(19) United States
(12) Patent Application Publication
(10) Pub. No.: US 2006/0215984 A1
(43) Pub. Date: Sep. 28, 2006

(54) Device and method for recording information

(76) Inventors: Jan Alexis Daniel Nesvadba, Eindhoven (NL); Declan Patrick Kelly, Eindhoven (NL); Igor Nagorski, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,230

(22) PCT Filed: Mar. 15, 2004
(86) PCT No.: PCT/IB04/50253

§ 371 Date: Sep. 12, 2005

(30) Foreign Application Priority Data
Mar. 18, 2003 (EP) 03100675.2

(51) Int. Cl. H04N 7/173; H04N 7/16; H04N 5/91

(52) U.S. Cl. 386/46; 725/134; 725/142

(57) ABSTRACT

A device for recording records digitally encoded video information on a record carrier according to a predefined recording format, such as DVD+RW. The device has a unit for gathering meta-data which describes parameters of the real-time information, and records the meta-data. The record carrier has to be compatible to existing recording devices which are not aware of the meta-data. Thereto the device has control means for recording the meta-data in at least one hidden location of the record carrier which hidden location is not or less likely accessible for storing data according to the predefined recording format.

The invention relates to a device for recording information.

The invention further relates to a method of recording information.

The invention further relates to a computer program product for recording information.

The invention further relates to a device for retrieving information from a record carrier.

The invention further relates to a record carrier.

A device and method for recording information on a record carrier are known from the European Patent Application EP 1052644A1, in which digitally compressed video data is recorded on an optical disc according to a video encoding standard, for example the MPEG2 format. The video information, including control and navigation information, is stored according to a predefined recording format, in particular one of the DVD (Digital Versatile Disc) video recording formats. The apparatus has input means for receiving video information, and recording means for recording the video information in a stream of packets on the record carrier, in particular in video units in a video file. The packets may contain video, audio or other information, e.g. subtitles or navigation information. The device further has control means for generating thumbnails, i.e. small images representative for the video, or thumbnail control information. The thumbnail control information includes information for generating a thumbnail image which is generated based on the contents of the video data, and information for using the thumbnail pictures in a menu corresponding to the contents of the video data. The thumbnail data is accessible via thumbnail access control information added to the predefined video recording format. A problem of the known system is that the existing predefined video recording format has to be adapted to accommodate the thumbnail information, and that pre-existing recording devices that are not aware of the adaptation may accidentally erase the thumbnails or the thumbnail access control information.

It is an object of the invention to provide a system for recording and reproducing digitally encoded real-time information, which is able to accommodate additional content description information and is compatible with pre-existing recording and playback devices operating according to a predefined recording format

For this purpose, the device for recording information on a record carrier comprises recording means for recording marks representing digitally encoded real-time information, in particular video, according to a predefined recording format, and control means for gathering meta-data which describes parameters of the real-time information, and for recording the meta-data in at least one hidden location of the record carrier which hidden location is not or less likely accessible for storing data according to the predefined recording format.

The meta-data comprises content description information for multimedia content and additional information comprising parameters of real-time information such as video and/or audio. The meta-data is stored in hidden locations not used or less likely used with the existing framework of content data and control information provided by the existing format This has the advantage that the meta-data will not disturb pre-existing recording or playback devices, and will usually not be accidentally erased or damaged by such devices.

The invention is also based on the following recognition. The inventors have seen that current video processing systems can generate various types of content description data suitable in a recording/reproducing system for advanced user functions. Meta-data describes or is indicative for certain features of multimedia content such as key frames, commercial entries, silence, key-words etc. A meta-data entry for a multimedia frame can be available immediately or with a delay caused by statistical nature of the algorithms used in the video processing. Usually the meta-data is not available in broadcast multimedia, and is generated ‘on the fly’ in a recording system. Although such meta-data might be generated again, this would require accessing and processing substantially the complete video data. The meta-data can be stored shortly after storing the video. As the meta-data comprises content related user data, usually such data is stored in the user data zone on the record carrier. The inventors have seen that by storing the meta-data in hidden locations the recorded video content data is still fully compatible to the predefined recording format, and can be read and reproduced by pre-existing playback devices. Also pre-existing recording devices will usually not overwrite the hidden locations.

In an embodiment of the device the control means are arranged for recording the meta-data in a control area as the hidden location, which control area is separated from a data zone that is provided according to the predefined recording format for containing the digitally encoded real-time information. This has the advantage that the data zone can be used freely according to the predefined recording format. Hence there is a low risk that other existing recording devices, not aware of the meta-data, e.g. pre-existing devices or competitor recorders, will disturb or overwrite the meta-data.

In a further embodiment of the device above the control area is located near an anchor point provided according to the predefined recording format before a lead-out zone, or at a predefined location near the perimeter of the recordable area of the record carrier. Locating the control area near an anchor point has the advantage that the use of the storage area by existing devices is restricted. Further locating the control area at a predefined location near the perimeter of the recordable area of the record carrier has the advantage that such parts of the recordable area will remain mostly unused by said other recorders, and therefore the risk for overwriting is limited.

In a further embodiment of the device above the control area is located in a selected zone within a lead-in zone or a lead-out zone that are provided according to the predefined recording format, the selected zone being present but not containing any information to be used according to the predefined recording format, in particular the selected zone being a buffer zone, a reserved zone or a guard zone. This has the advantage that such zones are always required and will most likely remain undisturbed by said other recorders.

In an embodiment of the device the control means are arranged for recording the meta-data in user data packs within real-time storage units that are provided according to the predefined recording format, the real-time storage units containing predefined packs of the encoded real-time information or navigation information, and for providing access to the user data packs by storing pointers to user data packs in a hidden location, in particular by storing forward and/or backward pointers to user data packs in a user data pack, in stuffing locations in predefined packs, or in reserved fields in navigation packs, or for providing access to the data user packs by specifically locating the user data packs during said recording at predefined positions, or at a location near a predefined position in the event that the predefined recording format requires other information to be recorded at the predefined position. It is to be noted that the storage of the user data packs is located within the data zone for storing the real-time information itself, but that the user data packs will be ignored according to the pre-defined recording format. No access control data is included in the framework of control data of the predefined recording format, but the user packs are to be located by scanning a part of the real-time data until the first user pack has been found. The scanning effort can be reduced by locating the user data packs at or near predefined locations, e.g. relative to logical addresses or to the beginning a video file. This has the advantage that locating the meta-data is relatively easy.

These and other aspects of the invention will be apparent from and elucidated further with reference to the embodiments described by way of example in the following description and with reference to the accompanying drawings, in which

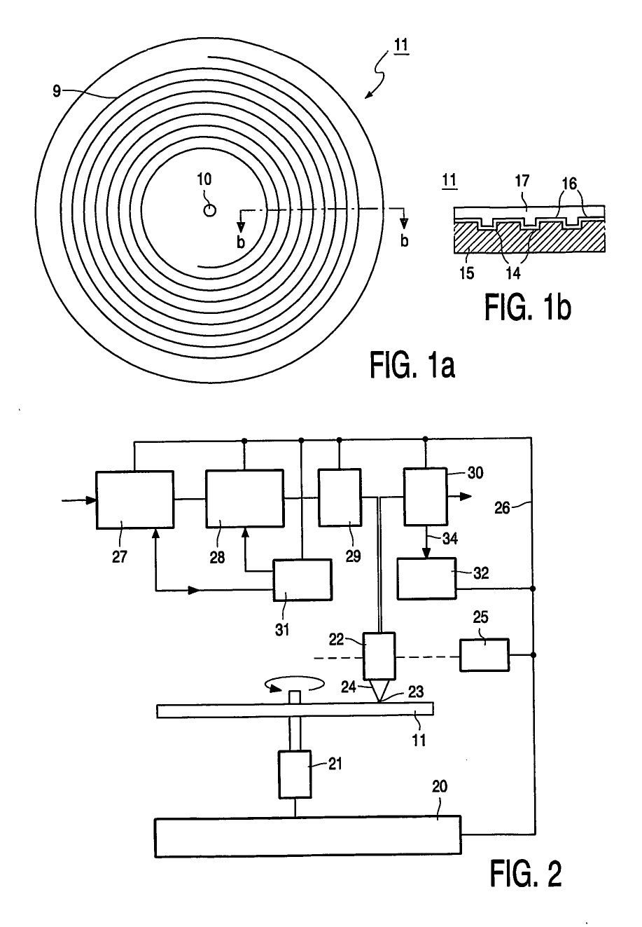

FIG. 1a shows a record carrier (top view),

FIG. 1b shows a record carrier (cross section),

FIG. 2 shows a recording and/or playback device, in accordance with the invention.

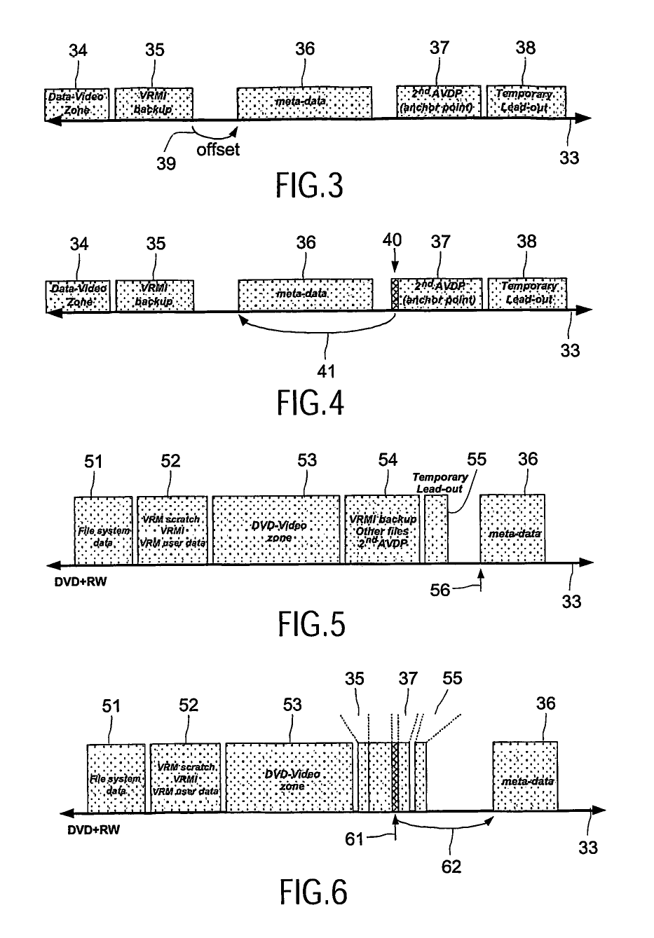

FIG. 3 shows storing meta-data near an anchor point at an offset, in accordance with the invention.

FIG. 4 shows storing meta-data near an anchor point using a meta-data location pointer, in accordance with the invention.

FIG. 5 shows storing meta-data at a fixed location outside the data zone, in accordance with the invention.

FIG. 6 shows another option of storing meta-data at a fixed location outside the data zone using a meta-data location pointer, in accordance with the invention.

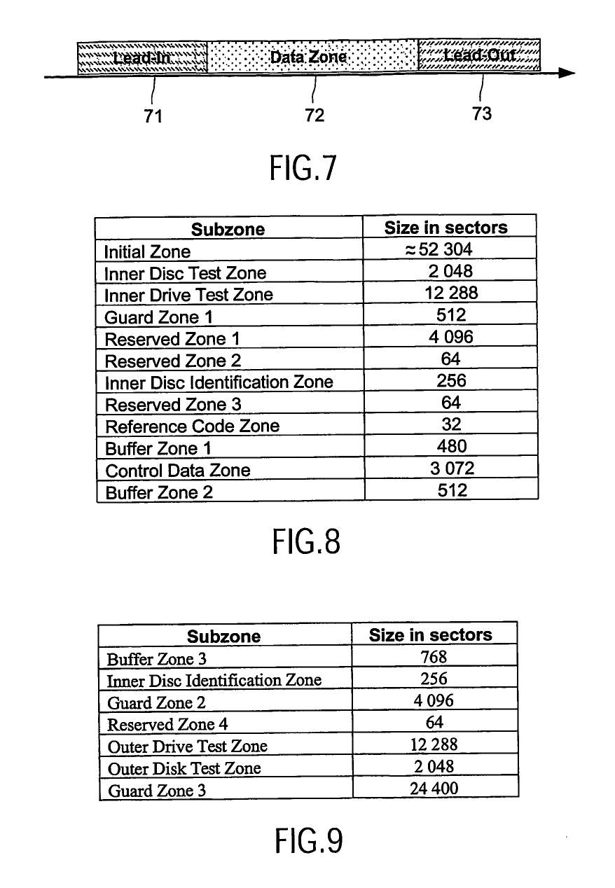

FIG. 7 shows an overview of recordable zones in a predefined recording format.

FIG. 8 shows the contents of a Lead-In Zone.

FIG. 9 shows the contents of a Lead-Out Zone.

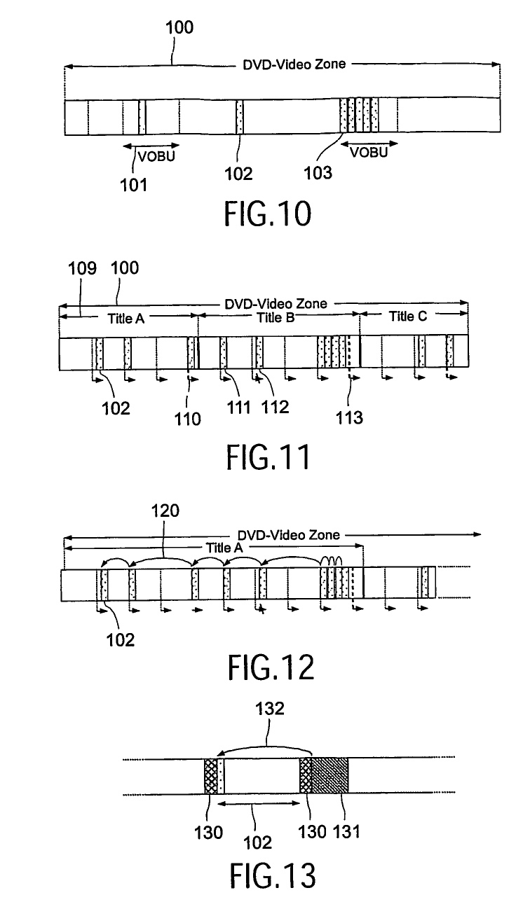

FIG. 10 shows using User Defined Packs to store meta-data, in accordance with the invention.

FIG. 11 shows using User Defined Packs to store meta-data located at predefined location, in accordance with the invention.

FIG. 12 shows using User Defined Packs to store meta-data and backward pointers, in accordance with the invention.

FIG. 13 shows a user defined pack and a pointer at a stuffing location, in accordance with the invention.

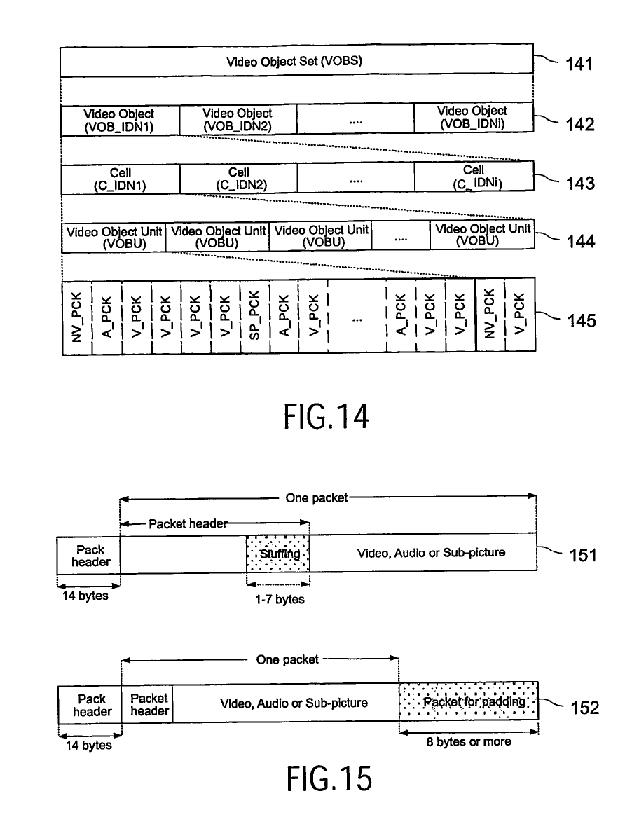

FIG. 14 shows the predefined recording format for recording video in DVD.

FIG. 15 shows stuffing or padding data within a packet for storing meta-data, in accordance with the invention.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-R and CD-RW, and writable versions of DVD, such as DVD+RW, and the high density writable optical disc using blue lasers, called Blue-ray Disc (BD). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 which enables a read/write head to follow the track during scanning. The track structure comprises position information, e.g. addresses, for indication the location of units of information, usually called information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying information representing digitally encoded video like MPEG2 encoded video information recorded according to a predefined recording format like the DVD format. Further details about the DVD disc can be found in reference: ECMA-267: 120 mm DVD—Read-Only Disc—(1997), and corresponding DVD video recording specifications.

FIG. 2 shows a recording device for writing information on a record carrier 11 of a type which is writable or re-writable, for example CD-R or CD-RW, or DVD+RW or BD. The device is provided with recording means for scanning the track on the record carrier which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an input unit 27, and modulator means comprising a formatter 28 and a modulator 29. The control unit 20 controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits. The input unit 27 processes the audio and/or video to unit of information, which are passed to the formatter 28 for adding control data and formatting the data, e.g. by adding error correction codes (ECC) and/or interleaving. For computer applications units of information may be interfaced to the formatter 28 directly. The formatted data from the output of the formatter 28 is passed to the modulation unit 29, which comprises for example a channel coder, for generating a modulated signal which drives the head 22. Further the modulation unit 29 comprises synchronizing means for including synchronizing patterns in the modulated signal. User real-time information is presented on the input unit 27, which may comprise of compression means for input signals such as analog audio and/or video, or digital uncompressed audio/video. Suitable compression means are described for audio in WO 98/16014-A1 (PHN 16452), and for video in the MPEG2 standard. The input signal may alternatively be already encoded. The formatted units presented to the input of the modulation unit 29 comprise address information and are written to corresponding addressable locations on the record carrier under the control of control unit 20 according to a predefined recording format. It is to be noted that further in the text reference is made to the predefined recording format of DVD+RW as an example of such a format. For other predefined formats similar hidden locations can be defined. The hidden locations are locations on the record carrier, which are not or less likely accessible for storing data according to the predefined recording format.

The device has a meta-data unit 31 coupled to the input unit 27 for gathering meta-data for the real-time information to be recorded. The meta-data unit is coupled to the formatter 28 for storing the meta-data in hidden locations under the control of control unit 20 as described below. Meta-data describes certain features of multimedia content (key frames, commercial entries, silence, key-words etc.), and can be generated by extraction algorithms implemented in the meta-data unit 31, or may be provided with the real-time data, e.g. by broadcasting or via another source such as Internet For example, the broadcaster could provide a table of chapter start entries either in the broadcast or on a web site. Meta-data entries are usually linked to a multimedia frame or a group of frames, and entries fall into possible groups as follows. A first group is discrete meta-data entry, in which the entry describes an individual frame (of audio, video, or part of text). Examples: key frame, black frame, uniluminance frame etc. A second group is segment meta-data entry, in which the entry describes a contiguous part of multimedia content, i.e. a scene. Examples: commercial, summary, letterbox 4:3/16:9, interlaced video, progressive video etc. A third group is continuous meta-data entries, in which meta-data is stored for the whole sequence e.g. average/dominant color for all frames or a regular sample of frames, audio amplitude etc.

The input to the input unit 27 may be either analogue or digital multimedia (e.g. AN content). On record carrier the multimedia content will be stored in a compressed digital format e.g. MPEG-2 (Program stream, Transport stream etc.). During recording the meta-data unit 31 gathers meta-data about the content, i.e. the unit may generate, receives with a broadcast or actively acquire data from a network. The following cases are to be considered. For analogue input the meta-data can be generated by the encoder producing the compressed digital multimedia data. For transcoded digital input the digital multimedia input is being transcoded (e.g. to control the bit-rate and hence the record time on disc) and the transcoder can generate the meta-data For transparent digital multimedia the digital content received is recorded without modification. In this case some parsing and processing of the incoming content is necessary to generate the meta-data The meta-data usually consists of a sequence of entries, each one consisting of some of the following information: Entry Type (e.g. key frame, black frame, commercial segment, silence audio segment), Time code (optional), Start Pointer, End Pointer (optional), Data (optional). In addition to pointers based on positions on disc or offsets within a file also a time code (e.g. MPEG-2 PTS) as well as the pointers to identify where in time within the multimedia content the event occurs may be stored. Suitable ways for extracting the meta-data are for example known from U.S. Pat. No. 6,137,544 (scene detection and frame filtering) or WO 98/55942 (visual indexing system).

The device is provided with a meta-data read unit 32 for retrieving the meta-data under control of the control unit 20 from the hidden locations as described below. The meta-data is presented to the user in combination with the real-time information retrieved via the read unit 30. The meta-data are provided to enable user browsing and navigation features (e.g. commercial skip, key frame browsing, content summary).

It is noted that the device as shown in FIG. 2 has recording and reproducing functions. Alternatively a playback device for only retrieving information from a record carrier contains the scanning elements and the read processing circuitry, but does not have the input unit 27, the formatter 28, the modulator 29, and the meta-data unit 31.

FIG. 3 shows storing meta-data near an anchor point at an offset. A part of the DVD+RW format recordable area is schematically shown, in particular the area at the end of the recorded part. An overview of the DVD+RW recordable area of a record carrier is given in FIG. 5. Storing meta-data near an anchor point is an embodiment of recording the meta-data in a control area as the hidden location, which control area is separated from the data zone that is provided according to the DVD+RW format for containing the digitally encoded real-time information. In FIG. 3 arrow 33 represents the upper part of the recordable area The main user data are stored in the Data-Video zone 34, which is terminated by VRMI backup 35, which is a backup copy of the Video Recording Manager Information (VRMI) at a predefined location before (and relative to) an anchor point 37 called 2^{nd} AVDP (Anchor Volume Description Pointer), which is followed by a temporary Lead-Out 38. The meta-data 36 is stored after the VRMI backup 35. A location mechanism for the data stored in that area is recommended. A solution is to store the meta-data file at a fixed offset 39 from VRMI backup. The DVD+RW format includes the VRMI backup as the element terminating the Data-Video Zone 34, and hence will not overwrite the meta-data 36. A total storage space of about 6 MB is reserved for VRMI backup and other files and the 2nd anchor point. This results in a storage space of 5,936 MB (=6 MB−2*32 kB) for other files (located between VRMI backup and 2nd anchor point). This area remains unchanged as long as the size of DVD-Video zone does not change, but it is stored in a new location every time the DVD-Video zone (recorded area) grows. In a recorder not aware of the meta-data only the standardized structures in the area are stored, while the meta-data will not be maintained. In an embodiment of the device the meta-data are re-generated or recovered from other hidden locations and re-stored at the new location in the event that the device detects that the storage area has been moved.

FIG. 4 shows storing meta-data near an anchor point using a meta-data location pointer. The meta-data 36 is stored after the VRMI backup 35. A location mechanism for the data stored in that area is as follows. A meta-data location pointer 40 is stored directly before the 2^{nd} anchor point 37 to specify the location of the meta-data file 36 which is located before the 2^{nd} Anchor point, as indicated by arrow 41.

FIG. 5 shows storing meta-data at a fixed location outside the data zone. The DVD+RW recordable area contains the following relevant areas. File system data 51 is located before the first DVD+RW video data and optionally partly after the last DVD+RW Video data. VRMI (Video Recording Manager Information) 52 is located before DVD+RW Video data. It includes information to identify which type of recorder has generated the DVD-Video menus on the disc. A 1st AVDP (Anchor Volume Description Pointer) is stored at a fixed location (not shown) of LSN (logical sector number) 256. After VRMI 52 a DVD-Video zone 53 follows for storing the real-time information. Thereafter the VRMI backup and 2^{nd} AVDP 54, and a temporary lead-out 55 follow, as described above with FIG. 3. The VRMI backup has a size of 32 kB. It contains a bit true copy of VRMI for error correction purposes. The 2nd AVDP contains backup copy of the 1^{st} AVDP (Anchor Volume Description Pointer). It has a size of 32 kB and it may be used when the 1^{st} AVDP cannot be read. It is found by reading the location of the end of Data Zone from the physical format information in the Lead-in. It is stored in the last sector of the volume space.

The meta-data file 36 is placed at a fixed physical position 56 at the end of DVD+RW medium beyond the temporary Lead-out 55. The fixed location is known to the recording and/or playback device that supports the meta-data function. A possible physical location on DVD+RW is as follows. DVD+RW discs are CLV formatted. The CLV format is used for all audio and video recordings. A CLV formatted DVD+RW holds 4.7 billion bytes (4.37 gigabytes). One sector of a DVD+RW has a size of 2 kB. The total number of sectors of a DVD+RW reaches (4.37*1024ˆ2)/2=2291138. We assume that we require a storage capacity of 20 MB (10 MB/hour video data, 2 hours of video on DVD+RW in Standard Play mode). Therefore meta-data should be stored at physical position/sector 2280000 (=2291138−10000). It is very unlikely that the last 20 MB of a 4.7 GB will be used for recording, and therefore in most cases other recorders will not damage this area. The integrity of the data can be checked in the way described below by CRC.

FIG. 6 shows storing meta-data at a fixed location outside the data zone using a meta-data location pointer. The recordable area of according to DVD+RW is shown similar to FIG. 5. Just before the 2^{nd} anchor point 37 a meta-data location pointer 61 in included, pointing to the location of the meta-data file 36 as indicated by arrow 62.

FIG. 7 shows an overview of recordable zones in a predefined recording format. The recordable area starts with a Lead-In zone 71, followed by a Data zone 72 and a finally a Lead-Out zone 73. User data such as real-time information is stored in the Data Zone 72. According to the invention meta-data which describes the content of the real-time information is stored in hidden locations, in particular in the lead-in zone 71 and/or the lead-out-zone 72. The format of DVD+RW Lead-In Zone and Lead-Out Zone is strictly defined in the DVD+RW Video standard (see FIGS. 8 and 9 for details). Some areas are not used (i.e. reserved), and are now used to store meta-data.

FIG. 8 shows the contents of a Lead-In Zone. The Lead-In Zone is the innermost Zone of the Information Zone as indicated with FIG. 7. The table shown in FIG. 8 shows the various subzones, and the sizes in sectors. One sector contains 2 kB (2048 bytes) User Data, and an ECC block represents 16 sectors (32 kB). The usage of each subzone is specified by DVD+RW Video standard. The following subzones are kept vacant without any provisions of possible use and can be used to store meta-data: Buffer Zone 1 (480×2 kB) and Buffer Zone 2 (512×2 kB). In total the vacant area in the Lead-In Zone amounts to 1984 kB, which can be used for storing the meta-data

FIG. 9 shows the contents of a Lead-Out Zone. The Lead-Out Zone is the outermost Zone of the Information Zone as indicated with FIG. 7. The table shown in FIG. 9 shows the various subzones, and the sizes in sectors. The following subzones are kept vacant without any provisions of possible use and can be used to store meta-data: Buffer Zone 3 (768×2 kB), Reserved Zone 4 (4 096×2 kB) and Guard Zone 3 (24 400×2 kB). In total the vacant area in the Lead-Out Zone amounts to 60 064 kB.

FIG. 10 shows using User Defined Packs to store meta-data. The DVD-Video zone 100 is schematically indicated, and video data is stored in the DVD-Video zone 100 in recording units called VOBU 101 (further explained with FIG. 14). Within the VOBU, and in addition to the type of packs that are defined by the DVD-Video specification, additional packs called User Defined Packs (UD_PCK) 102, 103 are inserted, either as a single User Defined Pack 102 or as a cluster of consecutive User Defined Packs 103. The User Defined Packs of 2 kByte contain a 14 byte Pack header followed by a 2034 byte private_stream_{—}1 packet (as defined for MPEG2 by ISO/IEC 13818-1) with a sub_stream_id, which is equal to FFh (provider defined stream, as defined by the DVD Video specification). The DVD+RW Format Specification defines that correct playback devices should be robust against packs in the real-time stream containing a private_stream_{—}1 packet with a provider defined stream and new data stream types in packs with a private_stream_{—}1 packet with a sub_stream_id different from the ones defined in DVD-Video. Due to the definitions given in the DVD+RW predefined recording format meta-data can be stored at chunks of 2034 bytes as the User Defined Packs.

The basic idea is to store the meta-data in user-defined packs throughout the recording. In addition locating the user-defined packs is arranged as follows. Just scanning the recording is impractical because it will take too much time to find/read the meta-data packs. The required frequency of meta-data User Defined Packs is as follows. In a practical embodiment the actual statistics generated for meta-data purposes amount to 150 bytes/frame, which consist out of approx. 100 bytes video information and 50 bytes audio information. With 150 bytes/frame with PAL frame rate of 25 Hz the storage capacity requirement per second results in 150 bytes/frame*25 frames/second=3750 bytes/second=>˜2*2 kB UD_PCK/second. Assuming a bandwidth of 4 Mb/second (600 kB/s) of A/V information the required storage capacity per second is 600 kB for A/V content and 2*2 kB for meta-data statistics. The generated meta-data are produced it real-time at encoder/codec side while recording the content. This implies that the meta-data are stored delayed in relation to the content they belong to due to decision delays (filters) of the system. Using interleaved meta-data chunks stored in the DVD-Video Zone requires restoring the meta-data information at playback into memory in order to have the correct meta-data for actual reproduction of the content.

In an embodiment to improve the read time backward pointers are included in each meta-data pack to the previous meta-data pack. Therefore, once the last pack has been found the drive can jump to each previous one and only read the meta-data packs. In a further embodiment also forward pointers are included by buffering the data before it is written to disc and calculating the forward pointers. Because there is a pack every half second it is only necessary to buffer half second of video to generate the forward pointer. Typically more than half second is buffered to generate other forward pointers, e.g. for trickplay. For forward pointers beyond the buffer capacity the distance can be predicted, and the next UD_PCK can be located as close as possible to this predicted location. In the event that no next UD_PCK is available when recording at the predicted location, or to extend the pointer range, a further pointer may be stored instead on the predicted location.

To reduce the amount of meta-data, the features derived from the meta-data are stored instead of the raw meta-data. This will require significantly less data and so can be read much faster, however, there is a problem finding the packs. Suppose it is sufficient to have a single pack for every half-hour of video. We can again use backward pointers to link to previous meta-data packs but there is a problem finding the last pack to start from. It is not sufficient to store a meta-data pack at the end of the recording because the user may record over the end of the recording. If we only know that there is a meta-data pack every half hour then the system must read a half hour of video to search for the pack. This would be very time consuming.

In an embodiment User Defined Packs with meta-data are stored repetitively. Having a low frequency for the User Defined Packs means the impact of the loss of such a pack due to e.g. editing will become more relevant. A solution to avoid such an impact is to periodically repeat the last User Defined Pack with meta-data until a new User Defined Pack is available. Backward pointers (as described below) refer to the previous pack with different data, not a previous pack of which the current pack is a repetition.

In an embodiment the meta-data, or pointers to the meta-data stored in other hidden locations, are recorded in hidden locations within the encoded real-time information, in particular in the user data of MPEG-2 video elementary stream. The MPEG-2 video standard (see ISO/IEC 11172-2) defines 3 elementary video stream entities, such as video sequence, GOP, and picture, whose headers may contain user data The user data is inserted in the video stream by encoder and retrieved by decoder. In order to perform such an operation the encoder supports user data insertion, or, at least, dummy bits insertion, with actual data to be filled in after the stream leaves the encoder. The retrieval of user data is done on the output of decoder. Usually the capacity of the decoder's internal buffer for decoded data is limited, so the operation is time-critical. Since the video bitstream rate of encoder/decoder deteriorates upon user data insertion, the bit-rate of the user data inserted shall be kept under a certain threshold in order to let encoder/decoder properly process incoming/outcoming video. However for inserting pointers or a limited amount of meta-data sufficient capacity is available.

FIG. 11 shows using User Defined Packs to store meta-data located at predefined location. In the DVD video zone 100 several Video Title Sets (VTS), indicated as titles 109, are recorded. Each title includes a number of user defined packs UD_PCK 102 containing meta-data. The UD_PCK are stored at predefined locations 110. For each nominal predefined location a delay is allowed before the UD_PCK is stored. A fist UD_PCK 111 is stored at the predefined location without delay; a second UD_PCK 112 is stored with some delay after the corresponding predefined location. A last predefined location 113 for each title is indicated by a fat dashed line. The frequency of User Defined Pack and their physical location with a certain maximum delay is set by the system, e.g. meta-data packs are always stored at specific addresses in the video zone. The User Defined Packs are stored through the DVD-Video Zone at these predefined locations. In certain instances, when overhead information such as Packet headers have to be finished before User Defined Pack can be stored, a certain shift of the User Defined Pack from the predefined location is applied. The maximum delay can be specified and taken into account while searching for the last User Defined Pack.

FIG. 12 shows using User Defined Packs to store meta-data and backward pointers. The Figure shows storing meta-data in at least one UD_PCK 102 similar to FIG. 11. Backward pointers 120 connect the chain of User Defined Packs with the meta-data. User Defined Packs can be stored as single units or as a bundle of multiple Packs. User Defined Packs in the bundle have to contain the information that they are part of a bundle. In particular this is necessary for the situation that at the last predefined location a bundle of User Defined Packs is present to indicate that several packs have to be retrieved. The same concept can be used with forward pointers.

FIG. 13 shows a user defined pack and a pointer at a stuffing location. A user defined pack 102 is indicated by an arrow preceding a following pack, e.g. a video pack. Each pack has a pack header 130. The following pack may include stuffing data 131 according to the pre-defined recording format, as explained with FIG. 15 below. The stuffing data is used as a hidden location to store a pointer 132 to the start of the user defined pack 102. Hence to find the previous or next interleaved User Defined Pack this location information is stored in other packs (Audio, Video or Navigation Packs) in stuffing bytes (in Pack or PES headers) or Packets for padding. In practice the frequency of stuffing bytes or Packets for padding is quite sufficient for this purpose. The pointer can be either an absolute location pointer or a rather short relative location pointer.

FIG. 14 shows the predefined recording format for recording video in DVD. The DVD Video-Zone contains several Video Title Sets (VTS), which consist of multiple Video Object Sets (VOBS) 141. Each VOBS 141 is a collection of Video Objects (VOBs) 142, each VOB 142 is divided in multiple Cells 143 made up of Video Object Units (VOBUs) 144. Each VOBU 144 is a sequence of packs 145 in recording order. A VOBU starts with exactly one Navigation Pack (NV_PCK) and continues with multiple Audio and Video Packs (A_PCK, V_PCK) and (optionally) Sub-picture packs (SP_PCK). A VOBU typically comprises 1 Group Of Pictures (GOP) representing a video presentation period of at least 0.4 seconds and at most 1 second. Each Pack of the VOBU comprises a Pack Header and one or more Packets (PKT) containing the actual data The Pack length is 2048 bytes. If Pack length is less then 2048 bytes it shall be adjusted according to only one of the methods shown in FIG. 15. According to the predefined recording format the NV_PCK comprises a pack header, a system header, a PCI packet (PCI_PKT) and a DSI packet (DSI_PKT). The Presentation Control Information (PCI) is the Navigation Data to control the presentation of a VOBU. The PCI comprises 4 data structures. 2 of them, PCI_GI and RECI, contain reserved fields of 12 bytes and 18 bytes respectively, which in an embodiment are used as hidden locations to store the backward (forward) pointers to the previous (next) User Defined Pack. The Data Search Information (DSI) is the Navigation Data to search and to carry out seamless playback of the VOBU. The DSI is described in the DSI packet (DSI_PCK) which is in the Navigation pack (NV_PCK) and its content is renewed for every VOBU. The DSI comprises five pieces of information, and 471 bytes are reserved in the DSI, which in an embodiment are used as hidden locations to store the backward (forward) pointers to the previous/next (next) User Defined Pack. Due to the high and regular frequency of the NV_PCK such a solution is suitable for storing the pointers to meta-data in User Defined Packs.

In an embodiment the reserved bytes in the DSI and PSI are used to store the actual meta-data (total number of reserved bytes per VOBU=501 bytes) instead of using user defined packs. This could give a problem in future if these reserved bytes are later defined to have some use. In an embodiment the meta-data bytes are preceded by a length parameter or header, e.g. the number bytes used. This allows a player to differentiate between the bytes used for meta-data and further new defined bytes.

FIG. 15 shows stuffing or padding data within a packet for storing meta-data. According to the DVD predefined recording format packets 151,152 have a pack header and may contain one or more packets. Each packet has a packet header that may include 1 to 7 stuffing bytes at the end of the packet header just before the actual data as shown in the upper pack 151. Alternatively a pack may contain a packet for padding of 8 or more bytes as shown in lower pack 152. Either stuffing or padding data may be used as hidden locations for storing meta-data or pointers to meta-data as explained with FIG. 13.

In an embodiment of the device the integrity of the meta-data 36 is controlled by adding a cyclic redundancy check code (CRC) to the meta-data file. The CRC sum can be calculated either or the entire meta-data file or it can be calculated for parts of the meta-data, e.g. a number of blocks. This implies that the meta-data file is split into multiple blocks and for each block a CRC checksum is generated. This approach would guarantee that even when the meta-data file is partially overwritten the rest of the meta-data could still be recovered and used for browsing and navigation purposes. A trade off in block size has to be set. Big blocks hold the risk that bigger parts of the data get lost, small blocks will increase the time required for the CRC check. When retrieving the meta-data, a check of CRC will prove if meta-data in this area are still valid.

In an embodiment a check is performed if meta-data file overlaps with DVD-Data Zone (DVD-Video Zone+2nd Anchor point), or with other files known to the DVD file system. In the event of overlap the meta-data shall be considered to be invalid.

In an embodiment as well as storing a contiguous meta-data file as described with FIGS. 3 to 9, the meta-data is also stored in the DVD-Video Zone of the optical recordable medium interleaved with A/V data as described with FIGS. 10 to 15. If the contiguous meta-data file is lost, the application can restore the contiguous meta-data file from the interleaved chunks of meta-data information. Note storing the meta-data at the start/end of the recording of A/V data is not robust because the user can record over the start or end. Hence the meta-data can be stored repetitively.

Although the invention has been explained mainly by embodiments using the DVD+RW, similar embodiments like BD having a predefined recording format are suitable for applying the storage of meta-data. Further it is noted that a later version of such a predefined format may standardize at least some of the hidden storage locations, and thereafter co-exist with the older versions of the predefined recording format Also for the information carrier an optical disc has been described, but other media, such as a magneto-optical disc or magnetic tape, can be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording digitally encoded real-time information, such as video, according to a predefined recording format information on a record carrier, which device comprises recording means (22) for recording marks representing the digitally encoded real-time information, and
control means (20, 31) adapted
for gathering meta-data comprising parameters of the digitally encoded real-time information, and
for controlling recording the meta-data in at least one hidden location of the record carrier which hidden location is not or less likely accessible for storing data according to the predefined recording format.

2. Device as claimed in claim 1, wherein the control means (20) are adapted for recording the meta-data (36) in a control area as the hidden location, which control area is separated from a data zone that is provided according to the predefined recording format for containing the digitally encoded real-time information.

3. Device as claimed in claim 2, wherein the control means (20) are adapted to locate the control area near an anchor point (37) provided according to the predefined recording format before a lead-out zone (38), or at a predefined location near the perimeter of the recordable area of the record carrier.

4. Device as claimed in claim 3, wherein the control means (20) are adapted for recording a location pointer (40,61) referring to the meta-data, or for recording the meta data at a predefined offset (39) relative to an item recorded according to the predefined recording format.

5. Device as claimed in claim 4, wherein the control means (20) are adapted for recording the meta data at the predefined offset (39) relative to a backup copy of prescribed control data (VRMIbackup) recorded according to the predefined recording format.

6. Device as claimed in claim 2, wherein the control means (20) are adapted to locate the control area in a selected zone within a lead-in zone (71) or a lead-out zone (73) that are provided according to the predefined recording format, the selected zone not intended for recording information according to the predefined recording format.

7. Device as claimed in claim 6, wherein the control means (20) are adapted to locate the control area in the selected zone being a buffer zone, a reserved zone or a guard zone.

8. Device as claimed in claim 1, wherein the control means (20) are adapted
for recording the meta-data in user data packs (102) within real-time storage units (VOBU; 101) that are provided according to the predefined recording format, the real-time storage units (VOBU; 101) containing predefined packs of the encoded real-time information or navigation information, and
for providing access to the user data packs by storing pointers to the user data packs in the at least one hidden location by storing forward and/or backward pointers (120) to the user data packs in a user data pack, in stuffing locations (131) in predefined packs, or in reserved fields in navigation packs, or
for providing access to the data user packs by specifically locating the user data packs during said recording at predefined positions (110), or at a location near a predefined position (110) in the event that the predefined recording format requires other information to be recorded at the predefined position.

9. Device as claimed in claim 8, wherein the control means (20) are adapted to record at least one of the user data packs (102) repetitively at different hidden locations.

10. Device as claimed in claim 1, wherein the control means (20) are adapted for calculating an error detection code for at least part of the meta-data and for recording the error detection code with the meta-data.

11. Device as claimed in claim 1, wherein the control means (20) are adapted for recording the meta-data, or pointers to the meta-data stored in other hidden locations, in hidden locations within the digitally encoded real-time information.

12. Device as claimed in claim 11, wherein the control means (20) are adapted for recording the meta-data, or pointers to the meta-data stored in other hidden locations, in hidden locations within the user data of MPEG-2 video elementary stream.

13. Method of recording information on a record carrier, which method comprises
recording digitally encoded real-time information, such as video, according to a predefined recording format,
gathering meta-data which describes parameters of the digitally encoded real-time information, and
recording the meta-data in at least one hidden location of the record carrier which hidden location is not or less likely accessible for storing data according to the predefined recording format.

14. Computer program product for recording information, which program is operative to cause a processor to perform the method as claimed in claim 13.

15. Device for retrieving information from a record carrier, which device comprises reading means (30) for reading marks representing digitally encoded real-time information, such as video, according to a predefined recording format, and control means (20, 32)
for gathering meta-data which describes parameters of the digitally encoded real-time information from at least one hidden location of the record carrier which hidden location is not or less-likely accessible for storing data according to the predefined recording format.

16. Record carrier comprising a track carrying marks, which marks represent
digitally encoded real-time information, such as video, according to a predefined recording format, and
meta-data which describes parameters of the digitally encoded real-time information,
the meta-data being located in at least one hidden location of the record carrier which hidden location is not or less likely accessible for storing data according to the predefined recording format.
